(19) United States
(12) Patent Application Publication
(10) Pub. No.: US 2018/0317726 A1
(43) Pub. Date: Nov. 8, 2018

(54) SURFACE TREATING APPARATUS

(71) Applicant: Noriyoshi Sato, Kanagawa (JP)

(72) Inventors: Kansuke Sato, Kanagawa (JP); Mikako Sato, Kanagawa (JP); Noriyoshi Sato, Kanagawa (JP)

(73) Assignee: Noriyoshi Sato, Kanagawa (JP)

(21) Appl. No.: 15/968,017

(22) Filed: May 1, 2018

(30) Foreign Application Priority Data
May 2, 2017 (JP) 2017-091523
Apr. 23, 2018 (JP) 2018-082079

(51) Int. Cl. A47L 11/14; B08B 1/00

(52) U.S. Cl. CPC A47L 11/145; A47L 2201/04; B08B 1/008

(57) ABSTRACT

A surface treating apparatus has a first sheet containing unit; a second sheet containing unit; and a sheet driving unit to pull out an elongated sheet from the first sheet containing unit and move it to the second sheet containing unit as the apparatus moves on a surface to be treated. A sheet contacting member contacts one side of the sheet moving from the first sheet containing unit to the second sheet containing unit and brings the other side of the sheet into contact with the surface to be treated when the apparatus moves thereon. The elongated sheet is moved to wipe or apply wax or the like on the surface to be treated as the apparatus moves on the surface while renewing the portion of the sheet to be brought into contact with the surface when desired.

### CROSS-REFERENCE TO RELATED APPLICATIONS

The present application claims priority under 35 U.S.C. § 119 to Japanese Patent Application Nos. 2017-091523, filed on May 2, 2017 and 2018-082079 filed on Apr. 23, 2018. Each of the above applications is hereby expressly incorporated by reference, in its entirety, into the present application.

### BACKGROUND

The present disclosure relates to a surface treating apparatus, such as a surface treating apparatus for catching dust from a surface, such as a floor, by wiping the surface.

An autonomous robot for floor cleaning, which includes a movement driving system configured to autonomously move a cleaning element on a surface to be cleaned, is described in Japanese Unexamined Patent Publication No. 2011-200724. This robot includes a housing that is supported such that it moves on the surface to be cleaned. A first collecting unit, a liquid applicator, a spreading element, a scrubbing element, and a second collecting unit are mounted to the housing. The first collecting unit is configured to collect particulate matter that is released from the surface to be cleaned across a cleaning width. The liquid applicator is configured to apply a cleaning liquid to the surface to be cleaned. The spreading element is configured to spread the cleaning liquid applied to the surface to be cleaned such that the cleaning liquid is uniformly spread over the surface to be cleaned. The scrubbing element is configured to scrub the surface to be cleaned. The second collecting unit is configured to collect, from the surface to be cleaned, waste liquid that contains the cleaning liquid applied by the liquid applicator and any contaminants removed from the surface to be cleaned by the cleaning liquid. When the housing is moving in the forward direction, the first collecting unit goes before the liquid applicator, the liquid applicator goes before the spreading element, the liquid applicator goes before the scrubbing element, and the scrubbing element goes before the second collecting unit on the surface to be cleaned. During the cleaning operation, the scrubbing element contacts the surface to be cleaned and agitates the cleaning liquid applied to the surface to be cleaned, so that the agitated cleaning liquid is emulsified, decomposed, or mixed with contaminants to chemically react with the contaminants. The scrubbing element is configured to be replaceable by the user, or to be automatically fed.

That is, the scrubbing element goes before the second collecting unit, the liquid applicator goes before the scrubbing element and the spreading element, and the first collecting unit goes before the liquid applicator.

### SUMMARY

The above-mentioned scrubbing element is configured to be replaced by the user. In order to achieve cleaning for a long time using the autonomous robot, the user has to replace the scrubbing element on a regular basis to wash the scrubbing element. This imposes a limitation that the user has to stay in the vicinity the autonomous robot. Since no method to achieve the automatic feeding of the scrubbing element is disclosed, there is a demand for achieving the automatic feeding. Further, if the autonomous robot moving in the forward direction hits a wall, there may be cases where the second collecting unit cannot reach a position at which it can collect the cleaning liquid applied by the liquid applicator, which goes before the second collecting unit, and the cleaning liquid applied by the liquid applicator cannot be collected. In order to avoid such a situation, there is a problem that, in a room with obstacles, such as walls, desks, and chairs, in the forward direction of the autonomous robot, the movement of the liquid applicator has to be limited in the vicinity of the obstacles.

One aspect of the present disclosure is directed to providing a surface treating apparatus, which allows a surface treatment, such as floor wiping, for a long time by automatically feeding unused portions of a sheet. The disclosure is directed to providing a surface treating apparatus, which allows a surface treatment, such as wiping, even in the vicinity of a wall.

An aspect of the surface treating apparatus of the disclosure is a surface treating apparatus comprising a main body configured to move on a surface to be treated and treat the surface to be treated, the main body comprising:

a first sheet containing unit configured to contain an elongated sheet;

a second sheet containing unit configured to contain the elongated sheet coming from the first sheet containing unit;

a sheet driving unit configured to pull out the elongated sheet from the first sheet containing unit and move the elongated sheet toward the second sheet containing unit when the main body is making a forward movement;

a sheet contacting member configured to contact one side of the elongated sheet moving from the first sheet containing unit toward the second sheet containing unit and rotate along with the movement of the elongated sheet to bring the other side of the elongated sheet into contact with the surface to be treated when the main body is making the forward movement;

a wheel unit; and

a housing configured to hold the first sheet containing unit, the second sheet containing unit, the sheet driving unit, the sheet contacting member, and the wheel unit.

The main body is not limited to a self-propelled one, and may be propelled by an external force.

The main body may not necessarily be a unitary part, and a portion of the main body may be removable from the other portions. For example, the first sheet containing unit, the second sheet containing unit, and the sheet contacting member, or a portion including all or some of them may be formed as a unit, and the unit may be removable from the remaining portions of the main body, i.e., the unit may be replaceable.

The sheet driving unit may not necessarily keep moving the elongated sheet when the main body is making a forward movement, as long as it moves the elongated sheet for at least some period while the main body is moving.

The forward movement is not limited to a straight line forward movement, and includes a right turn forward movement and a left turn forward movement.

The description “rotate along with the movement of the elongated sheet” includes cases where the sheet contacting member rotates by being driven along with the movement of the elongated sheet, and also includes cases where the sheet contacting member drivingly rotates at the same circumferential velocity as the moving speed of the elongated sheet.

The wheel unit is not particularly limited as long as it contacts the surface to be treated to contribute to the movement of the main body. Examples thereof may include wheels that make rolling contact with the surface to be treated, as well as those having functions equivalent to wheels, such as a belt assembly including a pair of rollers and an endless belt that is wrapped around the pair of rollers and moves.

The housing is not particularly limited, and may be in the form of a case or a frame, for example.

The surface treating apparatus is not limited to one that wipes the surface to be treated. The surface treating apparatus may include those that cause some change of the surface to be treated while the apparatus is moving with bringing the elongated sheet into contact with the surface to be treated, such as an apparatus for waxing the surface to be treated using an elongated sheet impregnated with a wax.

According to the disclosure, when the main body moves, an unused portion of the elongated sheet can be fed to the surface to be treated to bring the thus fed unused portion of the elongated sheet into contact with the surface to be treated. This allows performing a surface treatment, such as cleaning of the surface to be treated (floor, for example) using an unused portion, such as a clean portion, of the sheet. Further, in the case where an automatically movable main body is provided, an unmanned long-time surface treatment, such as cleaning, can be achieved. Still further, according to the disclosure, the sheet contacting member rotates along with the movement of the elongated sheet, and this allows the elongated sheet to move without being dragged over the sheet contacting member, thereby achieving a smooth movement of the elongated sheet, which cannot be achieved due to a friction if the sheet contacting member is configured not to rotate along with the movement of the elongated sheet and the elongated sheet have to be dragged over the sheet contacting member to move (i.e., in the latter case, the smooth movement of the elongated sheet is hindered by the sheet contacting member).

### BRIEF DESCRIPTION OF THE DRAWINGS

FIG. 1 is a plan view of a floor wiping machine in embodiments of the disclosure,

FIG. 2 is a sectional view taken along the line Z-Z shown in FIG. 1,

FIG. 3 is a partial view showing details without showing a housing and an elongated sheet shown in FIG. 1,

FIG. 4 shows a state where the floor wiping machine shown in FIG. 1 is apart from a wall,

FIG. 5 shows a state where the floor wiping machine shown in FIG. 1 is close to a wall,

FIG. 6 is a diagram showing a relationship among a moving distance of the floor wiping machine shown in FIG. 1, a moving distance of the elongated sheet mounted to the floor wiping machine, and an elapsed time,

FIG. 7 shows a state where the floor wiping machine shown in FIG. 1 is cleaning the floor surface (state U),

FIG. 8 shows a state where the floor wiping machine shown in FIG. 1 is cleaning the floor surface (state V),

FIG. 9 shows a state where the elongated sheet is attached to a first cylindrical member in the floor wiping machine shown in FIG. 1,

FIG. 10 is a block diagram of the floor wiping machine shown in FIG. 1, and

FIG. 11 is a sectional view showing a state where the elongated sheet wound around the first cylindrical member is provided with a cover in the floor wiping machine shown in FIG. 1.

### DETAILED DESCRIPTION OF THE PREFERRED EMBODIMENTS

Hereinafter, embodiments of the disclosure will be described with reference to the drawings.

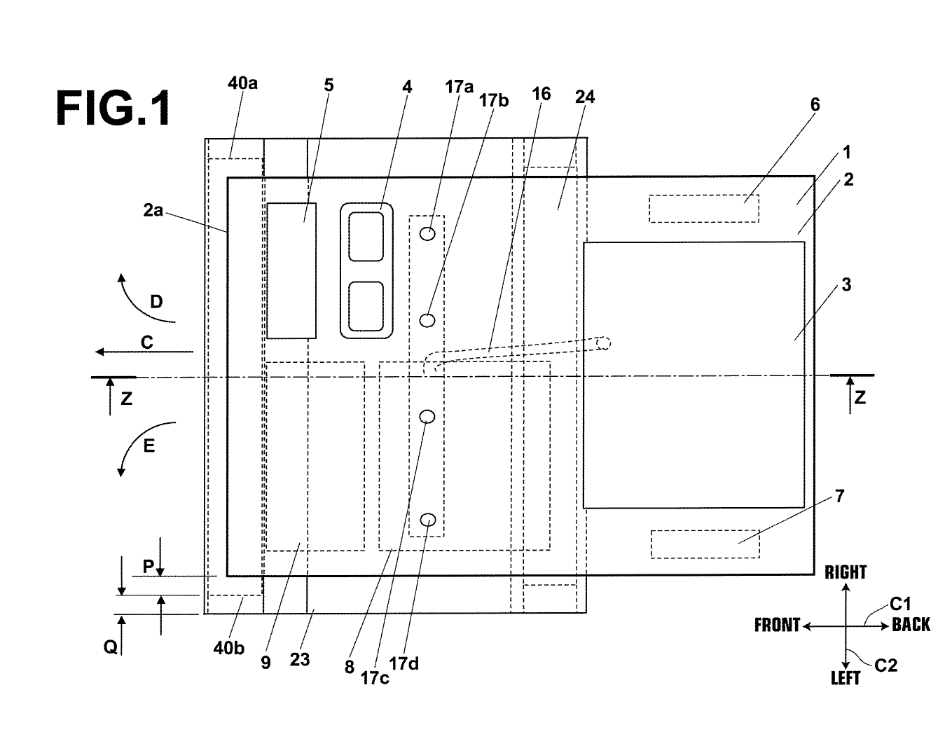

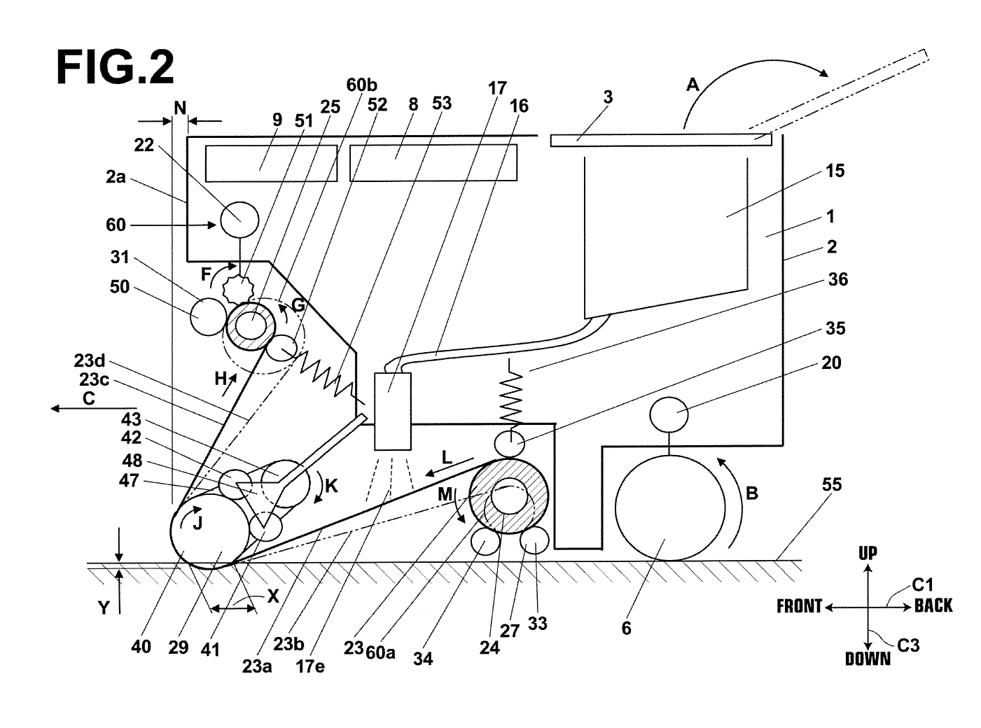

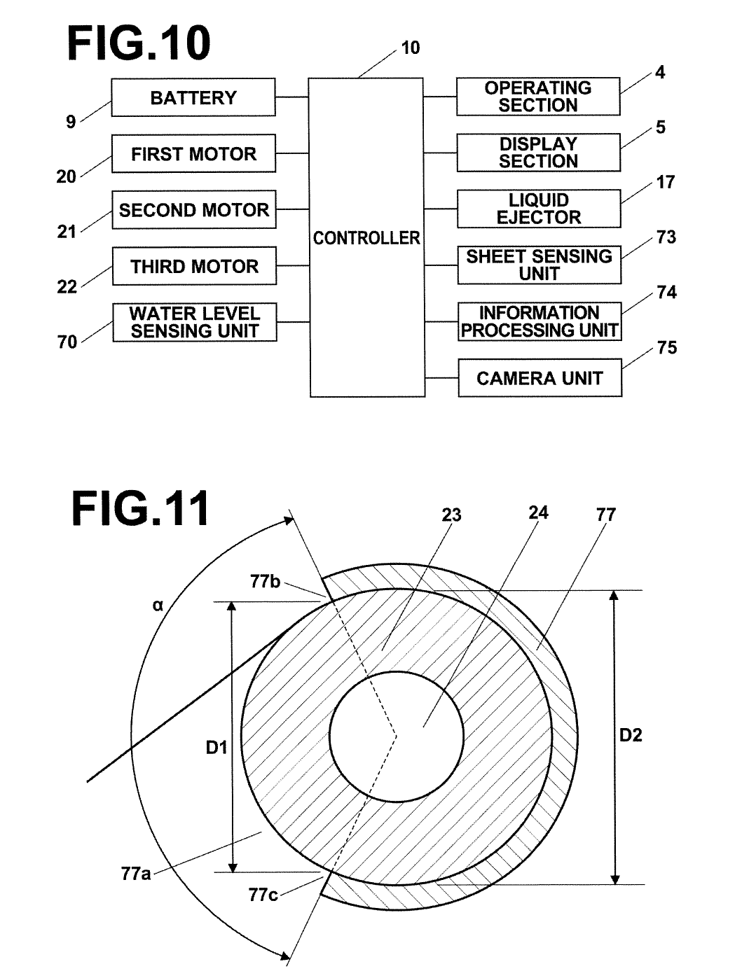

As shown in FIG. 1, a floor wiping machine 1, which is one embodiment a surface treating apparatus of the disclosure, includes a main body 2 having a housing 2a, which is substantially rectangular when viewed in plan view. The housing 2a includes, at the upper surface thereof, a lid 3, an operating section 4, and a display section 5. The housing 2a also includes therein a first wheel 6 (shown in dashed line), a second wheel 7 (shown in dashed line), an electric circuit unit 8, and a battery 9. The electric circuit unit 8 includes a controller 10 (see FIG. 10). The first wheel 6 and the second wheel 7 are one example of the wheel unit. It should be noted that, in the following description, directions, i.e., up, down, left, and right, relative to the main body 2 are describe as the directions of arrows C1, C2, and C3 shown in FIGS. 1 and 2.

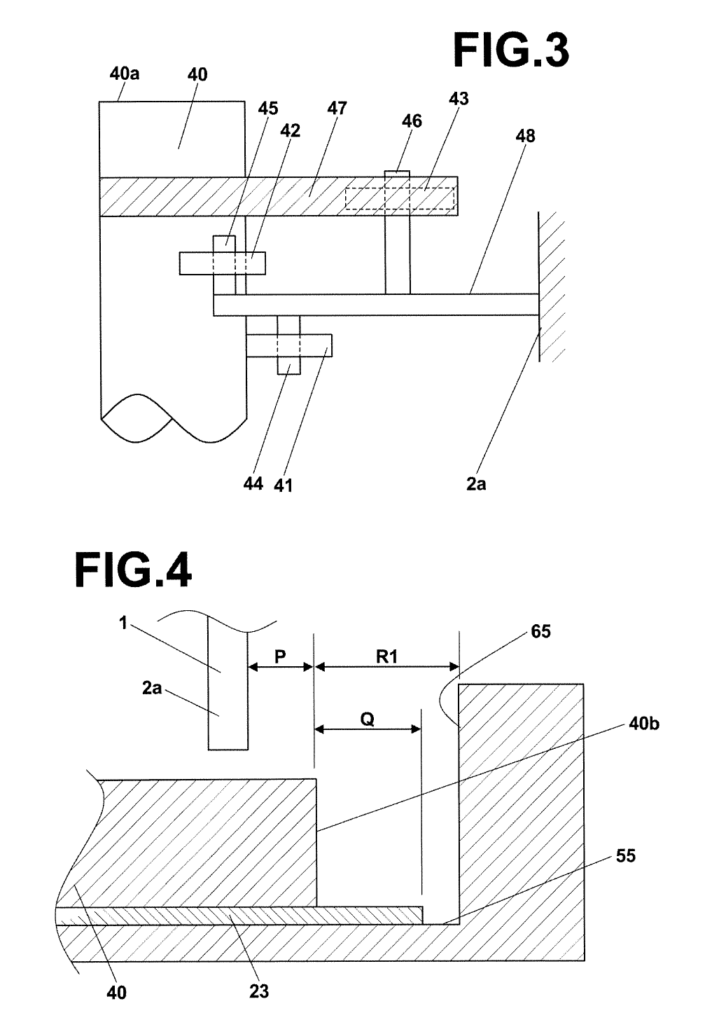

Now, FIG. 2 is described. The main body 2 further includes a container 15, a tube 16, a liquid ejector 17, a first motor 20, a second motor 21 (see FIG. 10), an elongated sheet 23, a first cylindrical member 24, a second cylindrical member 25, a first sheet containing unit 27, a sheet contacting unit 29, and a second sheet containing unit 31. The first sheet containing unit 27 includes a first roller 33, a second roller 34, a third roller 35, and a first spring 36. The sheet contacting unit 29 includes a third cylindrical member 40, which is one example of the sheet contacting member, a fourth roller 41, a fifth roller 42, a sixth roller 43, a fourth shaft 44 (see FIG. 3), a fifth shaft 45 (see FIG. 3), a sixth shaft 46 (see FIG. 3), a belt 47, and a mount plate 48. The second sheet containing unit 31 includes a seventh roller 50, an eighth roller 51, a ninth roller 52, and a second spring 53. The floor wiping machine 1 shown in FIG. 2 is movably placed on a floor surface (a surface of a wood floor, a tile floor, a laminated floor, or the like) 55, which is one example of a flat surface to be treated. It should be noted that the components of the main body 2 other than the housing 2a, namely, the wheel unit (the first wheel 6, the second wheel 7), the first sheet containing unit 27, the sheet contacting unit 29, the second sheet containing unit 31, the sheet driving unit 60 (the controller 10, the third motor 22, the eighth roller 51), which will be described later, etc., are directly or indirectly held by the housing 2a. It should be noted that the term “hold” as used herein means holding directly or indirectly.

Now, a detailed description is given using both of FIGS. 1 and 2. The lid 3 can be freely opened by the user. When the lid 3 is opened in the direction of arrow A (see FIG. 2), the container 15 is exposed. In FIG. 2, the state where the lid 3 is open is shown in two-dot chain line. The container 15 contains a liquid, such as a cleaning liquid (water, an oil solution, a mixture containing an alcohol, or the like). The tube (a liquid feeder) 16 is hollow, and one end of the tube 16 is connected to the bottom of the container 15, and the other end of the tube 16 is connected to the liquid ejector 17, so as to feed the liquid contained in the container 15 to the liquid ejector 17. When the liquid ejector 17 is operated, the liquid ejector 17 ejects an appropriate amount of the liquid fed thereto toward the elongated sheet 23. If the amount of the ejected liquid is too large, the liquid drips from the elongated sheet and traces of the liquid will be left on the floor. If the amount of the ejected liquid is too small, the effect of dissolving or loosening contamination will be decreased. The liquid stored in the container 15 is fed to the liquid ejector 17 through the tube 16. The liquid ejector 17 includes a first ejection port 17a, a second ejection port 17b, a third ejection port 17c, and a fourth ejection port 17d (see FIG. 1) for ejecting the liquid, such that the liquid fed from the container 15 and ejected through the ejection ports 17a, 17b, 17c, and 17d can be uniformly applied to the entire width (the entire width in the direction perpendicular to the direction of arrow C) of the elongated sheet 23. The liquid ejected from the liquid ejector 17 is denoted by 17e (see FIG. 2). If the liquid is continuously ejected from the individual ejection ports 17a, 17b, 17c, 17d, the amount of the liquid applied to the elongated sheet 23 will be too large, and the liquid will drip from the elongated sheet 23. In this embodiment, the liquid is ejected intermittently such that an appropriate amount of the liquid is ejected.

The first wheel 6 is connected to the first motor 20. The second wheel 7, which is parallel to the first wheel 6 and has the same diameter as the first wheel 6, is connected to the second motor 21. Both the first wheel 6 and the second wheel 7 contact and rotate on the floor surface 55 when they run on the floor surface 55. For example, when the main body 2 is placed on the floor surface 55, and when the first motor 20 and the second motor 21 are activated such that the first wheel 6 and the second wheel 7 rotate in the same direction at the same rotation speed, the main body 2 moves in the direction of arrow C (see FIGS. 1 and 2), i.e., moves forward, if the rotations of the first wheel 6 and the second wheel 7 are forward rotation (rotation in the direction of arrow B shown in FIG. 2) (hereinafter, this movement is referred to as “straight line forward movement”). If the first wheel 6 and the second wheel 7 rotates at the same rotation speed and the rotations thereof are backward rotation (rotation in the direction opposite to the direction of arrow B), the main body 2 moves in the direction opposite to the direction of arrow C, i.e., moves backward (hereinafter, this movement is referred to as “straight line backward movement”). If the rotation speed of the second wheel 7 is higher than the first wheel 6 and the rotations of the wheels 6 and 7 are forward rotation, the main body 2 moves in the direction of arrow D (see FIG. 1; hereinafter, this movement is referred to as “right turn forward movement”). If the rotation speed of the second wheel 7 is lower than the first wheel 6 and the rotations of the wheels 6 and 7 are forward rotation, the main body 2 moves in the direction of arrow E (see FIG. 1; hereinafter, this movement is referred to as “left turn forward movement”). If the rotation speed of the second wheel 7 is higher than the first wheel 6 and the rotations of the wheels 6 and 7 are backward rotation, the main body 2 moves in the direction opposite to the direction of arrow D (hereinafter, this movement is referred to as “right turn backward movement”). If the rotation speed of the second wheel 7 is lower than the first wheel 6 and the rotations of the wheels 6 and 7 are backward rotation, the main body 2 moves in the direction opposite to the direction of arrow E (hereinafter, this movement is referred to as “left turn backward movement”). As used herein, the term “forward movement” basically encompasses the straight line forward movement, the right turn forward movement, and the left turn forward movement, and the term “backward movement” basically encompasses the straight line backward movement, the right turn backward movement, and the left turn backward movement.

The elongated sheet 23 has a predetermined length, made of a material such as polyester, nylon, rayon, or cotton, and is in the form of an elongated strip made from a fabric or knit woven or knitted from fibers or a non-woven fabric such as paper or felt. One end 23e (see FIG. 9) of the elongated sheet 23 is held by and fixed to the first cylindrical member 24, which is one example of the first holding member configured to hold the one end of the elongated sheet 23, and is wound several turns on the first cylindrical member 24 in the counterclockwise direction as shown in FIG. 2. The other end of elongated sheet 23, which extends from the upper end of the first cylindrical member 24 and via the surface of the third cylindrical member 40 is held by and fixed to the second cylindrical member 25, which is one example of the second holding member configured to hold the other end of elongated sheet 23, and is wound several turns on the second cylindrical member 25 in the clockwise direction as shown in FIG. 2. The first cylindrical member 24, the third cylindrical member 40, and the second cylindrical member 25 are disposed such that the direction of the axial centers thereof is parallel to the left-right direction that is perpendicular to the front-back direction, and thus the elongated sheet 23 is moved from the first cylindrical member 24 via the third cylindrical member 40 to the second cylindrical member 25 in the front-back direction within the main body 2. When the elongated sheet 23 is attached to the main body 2, a right end 40a and a left end 40b of the third cylindrical member 40 extend rightward and leftward, respectively, by an amount P relative to the housing 2a when viewed in plan view (the state shown in FIG. 1), and the right end and the left end of the elongated sheet 23 project by an amount Q relative to the third cylindrical member 40.

It should be noted that, relative to the amount of projection P, both the amount of projection of the first cylindrical member 24 projecting in the same direction from the housing 2a and the amount of projection of the second cylindrical member 25 projecting in the same direction from the housing 2a are not greater than P. The reason of this is to avoid such a situation that, when the main body 2 moves in a room for cleaning and makes a forward movement parallel to a wall, the first cylindrical member 24 or the second cylindrical member 25 would otherwise contact the wall before the third cylindrical member 40 contacts the wall, and this would hinder cleaning of corners of the room.

The first roller 33 and the second roller 34 are spaced apart from each other and rotatably held in the housing 2a. One end of the first spring 36 is abutted on or fixed to the bearing of the third roller 35 that is rotatably held by the housing 2a. The other end of the first spring 36 is abutted on or fixed to the housing 2a. The first roller 33, the second roller 34, and the third roller 35 abut on the elongated sheet 23 wound on the outer circumference of the first cylindrical member 24. Since the diameter increases as the number of turns of the elongated sheet 23 wound on the first cylindrical member 24 increases, the first spring 36 is compressed and the third roller 35 urges the elongated sheet 23 wound on the first cylindrical member 24 toward the first roller 33 and the second roller 34. Similarly, since the diameter decreases as the number of turns of the elongated sheet 23 wound on the first cylindrical member 24 decreases, the first spring 36 is decompressed and the third roller 35 urges the elongated sheet 23 wound on the first cylindrical member 24 toward the first roller 33 and the second roller 34.

In this manner, regardless of the amount of the elongated sheet 23 wound on the first cylindrical member 24, the elongated sheet 23 wound on the first cylindrical member 24 is accommodated between the first roller 33 and the second roller 34 and the third roller 35 so as not to easily escape from between the rollers.

The seventh roller 50 is rotatably held in the housing 2a. The eighth roller 51, which is disposed apart from the seventh roller 50 and connected to the third motor 22, has depressions and protrusions on the surface thereof, and is rotatably driven by the third motor 22. One end of the second spring 53 is abutted on or fixed to the bearing of the rotatable ninth roller 52. The other end of second spring 53 is abutted on or fixed to the housing 2a. The seventh roller 50, the eighth roller 51, and the ninth roller 52 abut on the elongated sheet 23 wound on the outer circumference of the second cylindrical member 25. Since the diameter increases as the number of turns of the elongated sheet 23 wound on the second cylindrical member 25 increases, the second spring 53 is compressed and the ninth roller 52 urges the elongated sheet 23 wound on the second cylindrical member 25 toward the seventh roller 50 and the eighth roller 51. Similarly, since the diameter decreases as the number of turns of the elongated sheet 23 wound on the second cylindrical member 25 decreases, the second spring 53 is decompressed and the ninth roller 52 urges the elongated sheet 23 wound on the second cylindrical member 25 toward the seventh roller 50 and the eighth roller 51. FIG. 2 shows a state where a greater amount of the elongated sheet 23 is wound on the first cylindrical member 24 and thus has a larger diameter, and a smaller amount of the elongated sheet 23 is wound on the second cylindrical member 25 and thus has a smaller diameter.

When the third motor 22 is operated, the eighth roller 51 rotates in the direction of arrow F. The eighth roller 51 abuts on the elongated sheet 23 wound on the second cylindrical member 25, and has depressions and protrusions on the surface thereof. Thus, the second cylindrical member 25 rotates in the direction of arrow G along with the rotation of the eighth roller 51. The elongated sheet 23 is pulled onto second cylindrical member 25 in the direction of arrow H, and is wound and collected on the second cylindrical member 25 with increasing the diameter. The third cylindrical member 40 rotates in the direction of arrow J by being driven by the movement of the elongated sheet 23, which is fed in the direction of arrow H, and the fourth roller 41 and the fifth roller 42 abutting on the third cylindrical member 40 also rotate by being driven. Further, the belt 47, which is wrapped around the third cylindrical member 40 and the sixth roller 43, circulates along with the rotation of the third cylindrical member 40, and sixth roller 43 rotates in the direction of arrow K along with the circulation of the belt 47. As the elongated sheet 23 moves in the direction of arrow L from the first cylindrical member 24 toward the third cylindrical member 40, the diameter decreases with the first cylindrical member 24 rotating in the direction of arrow M. The amount of decrease of the elongated sheet 23 wound on the first cylindrical member 24 is equal to the amount of increase of the elongated sheet 23 wound on the second cylindrical member 25.

The third motor 22 is provided with a worm, and the eighth roller 51 or the rotating shaft (not shown) of the eighth roller 51 is provided with a worm wheel. Thus, when the third motor 22 rotates, the eighth roller 51 rotates; however, the third motor 22 does not rotate even if one attempts to rotate the eighth roller 51. That is, when the elongated sheet 23 is attached to the main body 2, the second cylindrical member 25 does not rotate in either of the forward direction (the direction of arrow G) and the backward direction even if one attempts to rotate the second cylindrical member 25. By controlling the rotation of the third motor 22 with the controller 10 such that the eighth roller 51 rotates only in the direction of arrow F, the elongated sheet 23 is wound on the second cylindrical member 25 only in one direction, and no backward rotation of the second cylindrical member 25 is allowed. This prevents slack of the elongated sheet 23 between the third cylindrical member 40 and the second cylindrical member 25, and between the third cylindrical member 40 and the first cylindrical member 24.

The third cylindrical member 40, which forms the sheet contacting member of the disclosure, is in the form of an elastic member made of an elastic material. The third cylindrical member 40 with the elongated sheet 23 partially wound thereon at substantially lower left half of the outer circumference thereof is compressed by an amount Y due to the weight of the main body 2. At the same time, the elongated sheet 23 forms a contact width X relative to the floor surface 55. If the third cylindrical member 40 were a rigid member, Y would be almost 0 and X would be as narrow as possible (i.e., become a line). As the third cylindrical member 40 is deformed by the amount Y, the elongated sheet 23 is pressed onto the floor surface 55 via the third cylindrical member 40. As the main body 2 moves in this state, the elongated sheet 23 pressed onto the floor surface 55 by the third cylindrical member 40 scrubs the floor surface 55 to catch contamination on the floor surface 55. It should be noted that the third cylindrical member 40 is not necessarily be entirely made of an elastic member, and only the outer circumference portion of the third cylindrical member 40 may be made of an elastic member. In this case, the thickness of the elastic member layer of the outer circumference portion may be equal to or greater than a desired amount Y of deformation due to the weight of the main body 2. Further, as the elastic material, rubber or sponge of urethane or silicone, for example, may be used. In the above-described embodiment, the weight of the main body 2 is supported by the wheel unit 6, 7 and the third cylindrical member 40 such that the weight of the main body 2 acts on the third cylindrical member 40 to compress the elastic member. However, for example, the third cylindrical member 40 may be rotatably supported with a shaft, and the shaft may be urged toward the floor surface 55 by a resilient means, such as a spring, having one end thereof supported by the housing 2a, so that the elastic member of the third cylindrical member 40 is compressively deformed.

Further, the third cylindrical member 40 projects forward by an amount N from the foremost end position of the housing 2a. When the main body 2 makes a forward movement in the direction of arrow C, if there is a wall in front of the main body 2, the elongated sheet 23 wound on the third cylindrical member 40 hits the wall before the housing 2a hits the wall. Ensuring the clearance N between the housing 2a and the wall allows avoiding such a situation that the housing 2a hitting the wall hinders the elongated sheet 23 wound on the third cylindrical member 40 from reaching the corner. That is, this allows the elongated sheet 23 to reach and clean the corner between the wall and the floor. Further, since the third cylindrical member 40 is made of an elastic member, as described above, the elastic deformation of the third cylindrical member 40 allows the elongated sheet 23 to reach further into the corner between the floor surface 55 and the wall.

As the elongated sheet 23 is fed from the first cylindrical member 24 to the second cylindrical member 25, the number of turns of the elongated sheet 23 wound on the first cylindrical member 24 decreases and the diameter thereof decreases. On the other hand, the number of turns of the elongated sheet 23 wound on the second cylindrical member 25 increases and the diameter thereof increases. A change of the outer diameter of the elongated sheet 23 wound on the first cylindrical member 24 after some of the elongated sheet 23 has been fed from the first cylindrical member 24, which initially has more elongated sheet 23 wound thereon, is shown in two-dot chain line at 60a. A change of the outer diameter of the elongated sheet 23 wound on the second cylindrical member 25 after some of the elongated sheet 23 has been fed to the second cylindrical member 25, which initially has less elongated sheet 23 wound thereon, is shown in two-dot chain line at 60b.

Further, a portion of the elongated sheet 23 between the first cylindrical member 24 and the third cylindrical member 40 when the first cylindrical member 24 is in the increased diameter state is shown at 23a. A portion of the elongated sheet 23 between the first cylindrical member 24 and the third cylindrical member 40 when the first cylindrical member 24 is in the decreased diameter state is shown at 23b. A portion of the elongated sheet 23 between the second cylindrical member 25 and the third cylindrical member 40 when the second cylindrical member 25 is in the decreased diameter state is shown at 23c. A portion of the elongated sheet 23 between the second cylindrical member 25 and the third cylindrical member 40 when the second cylindrical member 25 is in the increased diameter state is shown at 23d. As the first cylindrical member 24 changes from the increased diameter state to the decreased diameter state, the distance from the liquid ejector 17 to the elongated sheet 23 changes from the distance to the elongated sheet 23a into the distance to the elongated sheet 23b; however, this change is designed to be small enough for the liquid ejected from the liquid ejector 17 to reach the elongated sheet 23.

The purpose of the liquid ejection by the liquid ejector 17 is to feed the elongated sheet 23 impregnated with the liquid to the floor surface 55. In order to achieve this purpose, the liquid may be ejected onto the elongated sheet 23 wound on the first cylindrical member 24. Alternatively, the liquid may be ejected onto the surface of the third cylindrical member 40, and then transferred to the elongated sheet 23 contacting the third cylindrical member 40. In the case where the liquid ejector 17 is not used, the elongated sheet 23 impregnated with the liquid in advance may be used. In this case, a sealed structure may be provided around the elongated sheet 23 wound on the first cylindrical member 24 to prevent evaporation of the liquid from the elongated sheet 23.

The elongated sheet 23 wetted with the liquid ejected from the liquid ejector 17 can be used for wet type cleaning of the floor surface 55, and the elongated sheet 23 which is not wetted with the liquid ejected from the liquid ejector 17 can be used for dry type cleaning of the floor surface 55.

Next, the sheet contacting unit 29 is described in detail using FIG. 3. FIG. 3 is a plan view showing a part around the right end 40a of the third cylindrical member 40, without showing the housing 2a and the elongated sheet 23 shown in FIG. 1. The mount plate 48, which is directly or indirectly fixed to the housing 2a, has a fourth shaft 44, a fifth shaft 45, and a sixth shaft 46 fixed thereto. The fourth shaft 44 rotatably supports the fourth roller 41, the fifth shaft 45 rotatably supports the fifth roller 42, which has the same diameter as the fourth roller 41, and the sixth shaft 46 rotatably supports the sixth roller 43. The belt 47 is wrapped around the sixth roller 43 (shown in dashed line) and the third cylindrical member 40. A tensile force of the belt 47 pulls the third cylindrical member 40 toward the fourth roller 41 and the fifth roller 42, which are fixed to the housing 2a, and thus the third cylindrical member 40 is rotatably held by the housing 2a. Further, the belt 47 on the third cylindrical member 40 is sunk relative to the surface of the elastic member of the third cylindrical member 40 due to the tensile force such that the belt 47 collapses the elastic member by an amount corresponding to the thickness of the belt 47 and the surface of the belt 47 is substantially coplanar with the remaining portion of the surface of the third cylindrical member 40. It should be noted that the fourth roller 41, the fifth roller 42, the sixth roller 43, the fourth shaft 44, the fifth shaft 45, the sixth shaft 46, the belt 47, and the mount plate 48 shown in FIG. 3 are also provided at the left end 40b of the third cylindrical member 40 in the similar configuration.

FIG. 4 is a sectional view taken along the center axis position extending in the longitudinal direction (the left-right direction) of the third cylindrical member 40, showing a part of the main body 2 shown in FIG. 2 viewed from the front. Accordingly, the direction toward the viewer of the drawing from the drawing corresponds to the direction of arrow C. Using FIG. 4, a case where the floor surface 55 around a corner of a room is cleaned is described. The left end 40b of the third cylindrical member 40 projects by the amount P relative to the housing 2a. The elongated sheet 23 projects by the amount Q from the left end 40b of the third cylindrical member 40. A distance from the left end 40b of the third cylindrical member 40 to a wall 65 is R1 (where Q<R1). The elongated sheet 23 is pressed by the third cylindrical member 40 onto the floor surface 55, and thus is able to contact the floor surface 55 to clean the floor surface 55. A portion of the elongated sheet 23 in the range of Q is not pressed by the third cylindrical member 40 onto the floor surface 55 and lightly touches the floor surface 55 to catch dust on the floor surface 55. In the range from the left end of the elongated sheet 23 to the wall 65, the elongated sheet 23 does not contact the floor surface 55 at all, and thus is not able to clean the floor surface 55. Similarly, the right end 40a of the third cylindrical member 40 projects by the amount P from the housing 2a, and the elongated sheet 23 projects by the amount Q from the right end 40a of the third cylindrical member 40. Thus, cleaning of the floor surface by the right end 40a of the third cylindrical member 40 is achieved in the same manner as the left end 40b of the third cylindrical member 40 described above.

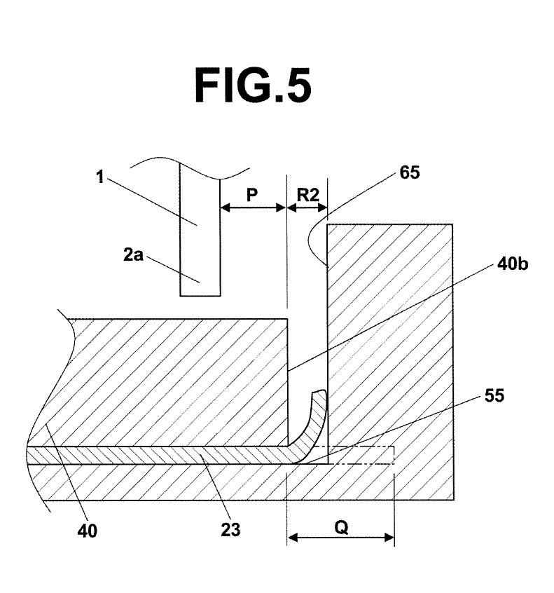

Next, description is given using FIG. 5. FIG. 5 shows a case where the distance R1 shown in FIG. 4 is reduced to R2 (where R2<Q). Using FIG. 5, a case where the floor surface 55 around a corner of a room is cleaned is described. The left end 40b of the third cylindrical member 40 projects by the amount P relative to the housing 2a. The elongated sheet 23 projects by the amount Q from the left end 40b of the third cylindrical member 40. A distance from the left end 40b of the third cylindrical member 40 to the wall 65 is R2. When the elongated sheet 23 is pressed by the third cylindrical member 40 onto the floor surface 55, the elongated sheet 23 contacts the floor surface 55 to be able to clean the floor surface 55. Since R2<Q, the elongated sheet 23 hits the wall 65; however, since the elongated sheet 23 is flexible, the elongated sheet 23 bends upward from the left end 40b of the third cylindrical member 40, and this allows making the distance R2 close to 0. Even when the distance R2 is 0, the housing 2a does not abut on the wall 65. As a result, the elongated sheet 23 can be pressed by the third cylindrical member 40 onto the floor surface 55 in the vicinity of the wall 65, thereby allowing cleaning of the floor surface 55 in the vicinity of the wall 65.

As described above, in this embodiment, the third cylindrical member 40 projects from the housing 2a in the width direction, i.e., in the left-right direction, of the main body 2 (the axial center direction of the first cylindrical member 24, the second cylindrical member 25, and the third cylindrical member 40), and the elongated sheet 23 projects from the third cylindrical member 40 in the width direction of the main body 2. With this configuration, cleaning of corners of a room is not hindered by the housing 2a hitting the wall 65. Although wiping of the floor in a room can be achieved without making the elongated sheet 23 project from the third cylindrical member 40 in the width direction of the main body 2, such an configuration is not suitable for cleaning the floor in the vicinity of the wall.

Next, moving distance of the main body 2 and moving distance of the elongated sheet 23 are described.

A case of dry type cleaning is described. If the main body 2 is continuing a forward movement (which is not limited to the straight line forward movement, and includes the right turn forward movement and the left turn forward movement) for a first predetermined time from the start of the forward movement, the third motor 22 is activated to start moving the elongated sheet 23 when the first predetermined time has elapsed from the start of the forward movement of the main body 2. If the forward movement of the main body 2 is continuing for a second predetermined time from the activation of the third motor 22, the third motor 22 is stopped after operating for the second predetermined time. If the main body 2 starts a backward movement (which is not limited to the straight line backward movement, and includes the right turn backward movement and the left turn backward movement) or stops within the second predetermined time from the activation of the third motor 22, the third motor 22 is stopped with a delay of Δt from the end of the forward movement of the main body 2.

In a case of wet type cleaning, before the main body 2 starts moving, a liquid from the liquid ejector 17 is fed to the elongated sheet 23, and then, the third motor 22 operates until a portion of the elongated sheet 23 wetted with the liquid is positioned between third cylindrical member 40 the floor surface 55, and the third motor 22 is stopped. Thereafter, the main body 2 starts moving.

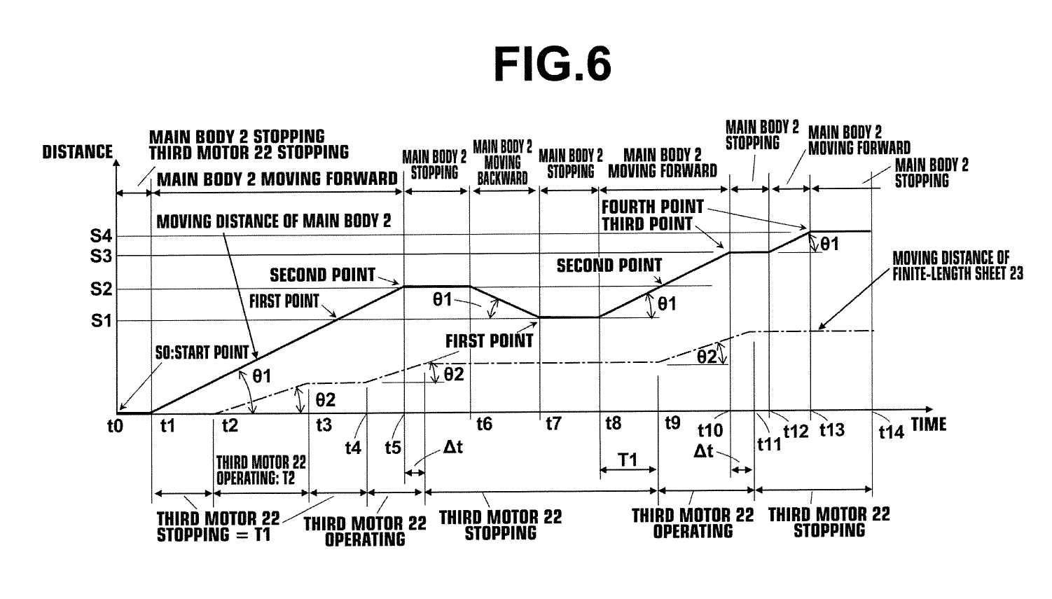

Now, using FIG. 6, amount of movement of the main body 2 and amount of movement of the elongated sheet 23 in the case of dry type cleaning, including the above-described matters, are described. As shown in FIG. 6, the third motor 22 being stopped indicates that the elongated sheet 23 is not moved, and the third motor 22 being operating indicates that the elongated sheet 23 is moved.

FIG. 6 shows time and moving distance (moving distance of the main body 2 and moving distance of the elongated sheet 23) when the floor wiping machine 1 performs dry type cleaning with making forward and backward movements on a flat floor surface. The horizontal axis represents time, and the vertical axis represents moving distance. A case where the main body 2 makes forward and backward movements is described. A start point of the main body 2 is S0. A distance from S0 to a first point is S1. A distance from S0 to a second point is S2. A distance from S0 to a third point is S3. S3 is longer than S2, and S2 is longer than S1. Further, a moving distance of forward and backward movements of the main body 2 per unit time is θ1, and a moving distance of the elongated sheet 23 per unit time is θ2. θ1 is greater than θ2.

The main body 2 stays at S0 for a period between time t0 and time t1, and the third motor 22 also does not operate. At time t1, the main body 2 starts a forward movement toward the first point, and the forward movement of the main body 2 is continuing at time t2 after the start of the main body 2 (where a time period between t1 and t2 is T1). Accordingly, the third motor 22 is activated to start moving the elongated sheet 23. That is, at time t2, the main body 2 has moved for the predetermined time period T1 and it is deemed that the elongated sheet 23 has caught a predetermined amount of dust. Accordingly, the elongated sheet 23 is moved to feed an unused sheet portion to the sheet contacting member 40.

At time t3 (where a time period from the activation of the third motor 22 to t3 is T2), the main body 2 is continuing the forward movement, and the third motor 22 is stopped to stop the movement of the elongated sheet 23 since, at the time t3, the time period T2 has elapsed from the time t2. The time period T2 is desirably a time period necessary for the portion of the elongated sheet 23 contacting the sheet contacting member 40 to be completely replaced with an unused sheet portion, or a time period longer than that. Thereafter, the main body 2 passes through the first point, and, since the main body 2 is continuing the forward movement after the time period T1 has elapsed from the time at which the third motor 22 is stopped, the third motor 22 is activated again to start moving the elongated sheet 23 after the time period T1 has elapsed (i.e., at time t4). Thereafter, if the main body 2 reaches the second point and stops there at time t5, the third motor 22 is stopped after Δt from the time when the main body 2 stops, although the time period T2 has not elapsed from the activation of the motor. Since the elongated sheet 23 is being moved, it is deemed that the elongated sheet 23 has caught a predetermined amount of dust, and therefore the movement of the elongated sheet 23 is continued for Δt to sufficiently replace the used sheet portion that has caught the predetermined amount of dust with an unused sheet portion. It should be noted that, if the main body 23 stops while the elongated sheet 23 is moving, the movement of the elongated sheet 23 is continued for Δt, and the main body 2 is not moved for Δt, i.e., until the movement of the elongated sheet 23 is completed. This is because that, if the main body 2 starts a backward movement, for example, before the movement of the elongated sheet 23 is completed, dust that is about to be caught by the elongated sheet 23 may be left on the floor surface 55.

After the main body 2 stops at the second point, the main body 2 starts a backward movement at time t6, and the main body 2 reaches and stops at the first point at time t7. The third motor 22 is not activated during the backward movement. At time t8, the main body 2 starts a forward movement again toward the third point, which is located beyond the second point.

The main body 2 starts a forward movement at the time t8, and, at time t9, the third motor 22 is activated to start moving the elongated sheet 23 since the time period T1 has elapsed from the start of the forward movement of the main body 2. The main body 2 passes through the second point and reaches the third point and stops there at time t10. At the time t10, since the time period T2 has not elapsed from the activation of the third motor 22, the third motor 22 is stopped after Δt from the time when the main body 2 stops, i.e., at time t11. The third motor 22 is stopped at the time t11, and then, the main body 2 starts a forward movement again at time t12, and stops at time t13. In this case, since a time period from the start to the stop of the forward movement of the main body 2 (a time period between the time t12 and the time t13) is not greater than T1, the third motor 22 is not activated and the elongated sheet 23 is not moved after the time t11. At the time t13, since a time period of the forward movement of the main body 2 is not greater than T1, it is deemed that the elongated sheet 23 has not yet caught the predetermined amount of dust. Accordingly, at and after the time t13, the main body 2 can start a movement again without moving the elongated sheet 23. It should be noted that, if the main body 2 stops a forward movement when the elongated sheet 23 is being moved, the movement of the elongated sheet 23 is continued until Δt elapses from the time at which the main body 2 stops, and the main body 2 is not moved forward or backward for Δt. Further, although not shown in FIG. 6, if the elongated sheet 23 is not being moved when the main body 2 stops a forward movement, the elongated sheet 23 may not be moved.

In the case of wet type cleaning, the liquid ejector 17 is operated for a predetermined time to wet the elongated sheet 23 immediately before the third motor 22 is activated, as shown in FIG. 6, and then the third motor 22 is activated to bring the wet elongated sheet 23 into contact with the sheet contacting member 29 as well as the floor surface 55 to effect the wet type cleaning. The ejection from the liquid ejector 17 is performed after the main body 2 starts a forward movement and immediately before the third motor 22 is activated, until the third motor 22 is stopped.

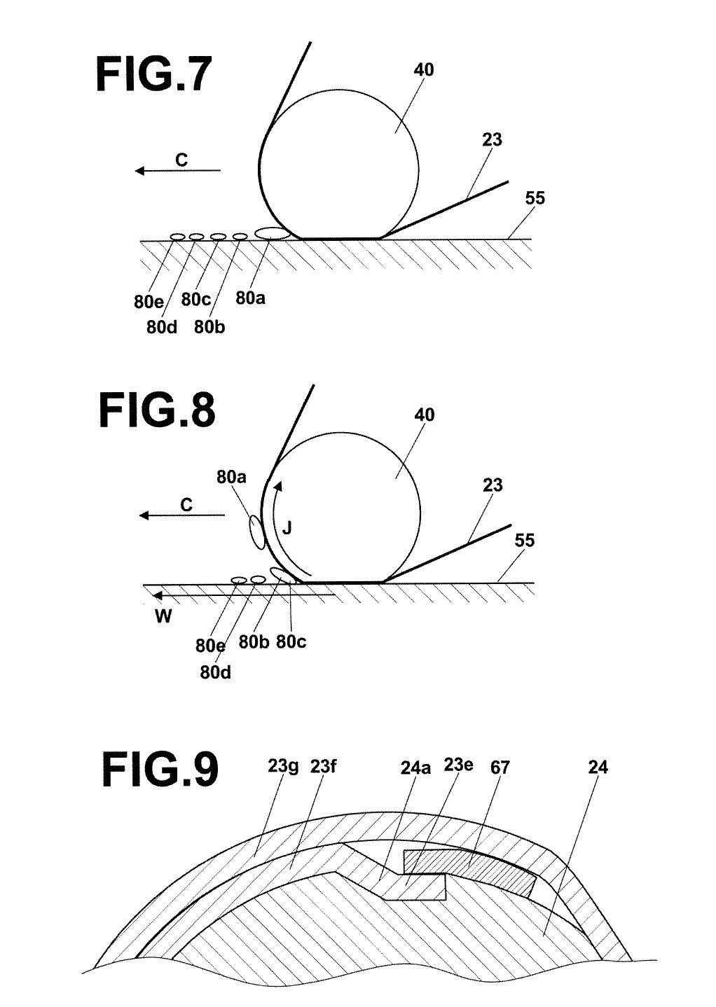

FIG. 7 is described. FIG. 7 shows a state between the time t1 and the time t2 shown in FIG. 6 (which will hereinafter be referred to as state U). In this state, the main body 2 makes a forward movement in the direction of arrow C, and dust on the floor surface 55 is collected as dust 80a at the boundary between the elongated sheet 23, which is in close contact with the surface of the third cylindrical member 40, and the floor surface 55. The dust 80a represents a collected accumulation of dust on the floor surface 55, and dust 80b, 80c, 80d, 80e which have not yet been in contact with the elongated sheet 23 are represented as being sufficiently smaller than the collected accumulation of dust 80a.

FIG. 8 is described. FIG. 8 shows a state between the time t2 and the time t3 shown in FIG. 6 (which will hereinafter be referred to as state V). The main body 2 makes a forward movement in the direction of arrow C, and the elongated sheet 23 is moved by the operation of the third motor 22 with the third cylindrical member 40 rotating in the direction of arrow J. Thus, the dust 80a contacting the elongated sheet 23 is caught by the elongated sheet 23, and is removed from the floor surface 55 by the movement of the elongated sheet along with the rotation of the third cylindrical member 40 in the direction of arrow J. At the boundary between the elongated sheet 23, which is in close contact with the surface of the third cylindrical member 40, and the floor surface 55, the dust 80b and the dust 80c are collected and form an accumulation of dust which is larger than the dust 80b and the dust 80c shown in FIG. 7. With the forward movement of the main body 2 and the movement of the elongated sheet 23, the dust 80b and the dust 80c are sequentially caught by the elongated sheet 23 to clean the floor surface 55.

No dust adheres to one side of the elongated sheet 23 contacting the third cylindrical member 40 (which will hereinafter be referred to as “back side”), and the caught dust adheres to the other side (which will hereinafter be referred to as “front side”) opposite from the back side of the elongated sheet 23. The elongated sheet 23 that has passed through the third cylindrical member 40 is wound on the second cylindrical member 25 such that the front side with dust adhering thereto faces the axial center of the third cylindrical member 25, i.e., inward. In other words, the front side with dust adhering thereto is not brought into contact with the seventh roller 50, the eighth roller 51, and the ninth roller 52, thereby avoiding such a situation that the dust transferred onto the surfaces of the seventh roller 50, the eighth roller 51, and the ninth roller 52 hinders smooth rotation of the rollers. Further, winding the elongated sheet 23 on the second cylindrical member 25 such that the front side with caught dust adhering thereto faces the axial center of the third cylindrical member 25 prevents the dust from falling off from the elongated sheet 23 onto the floor surface 55. Still further, the position the second cylindrical member 25 is determined such that the front side of the elongated sheet 23 that has passed through the third cylindrical member 40 faces upward (not to face the floor surface 55) in order to make the dust less likely to fall off from the elongated sheet 23 that has passed through the third cylindrical member 40 onto the floor surface 55.

When the main body 2 is making a forward movement in the direction of arrow C, the elongated sheet 23 on the surface of the third cylindrical member 40 is moved, by operation of the third motor 22, between the third cylindrical member 40 and the floor surface 55 (a position where the elongated sheet 23 passes through the sheet contacting member 40, i.e., contacts the floor surface 55) in the same direction (the direction of arrow W) as the direction of movement of the main body 2. In other words, the third cylindrical member 40 rotates in the direction that is opposite from the direction in which the first wheel 6 and the second wheel 7 rotate.

FIG. 9 is described. FIG. 9 shows a first turn 23f and a second turn 23g of the elongated sheet 23 wound on the first cylindrical member 24, and a first holding member 67 configured to hold the one end 23e of the elongated sheet 23 on the surface of the first cylindrical member 24. The first cylindrical member 24 includes a depression 24a configured to accommodate the one end 23e of the elongated sheet 23. The one end 23e of the elongated sheet 23 is held in the depression 24a of the first cylindrical member 24 by placing the one end 23e of the elongated sheet 23 in the depression 24a of the first cylindrical member 24 and then placing the first holding member 67 to span and cover the one end 23e of the elongated sheet 23 and the first cylindrical member 24. The first holding member 67 can be implemented by various configurations, such as using a sheet having an adhesive surface on the side facing the surface of the first cylindrical member 24, or a spring member configured to urge the one end 23e of the elongated sheet 23 onto the surface of the first cylindrical member 24 so as to prevent the one end 23e of the elongated sheet 23 from coming off from the depression 24a of the first cylindrical member 24.

The other end of the elongated sheet 23 is held on the second cylindrical member 25 using a second holding member (not shown). The manner of fixing the other end of elongated sheet 23 to the second cylindrical member 25 is the same as that described above with respect to holding the one end 23e, and explanation thereof is omitted. The first holding member 67 and the second holding member may not necessarily be implemented in the same manner, and may be selected as appropriate depending on costs and space.

FIG. 10 is described. The controller 10 is connected to the operating section 4, the display section 5, the battery 9, the liquid ejector 17, the first motor 20, the second motor 21, the third motor 22, a water level sensing unit 70, a sheet sensing unit 73, an information processing unit 74, and a camera unit 75. The controller 10, the third motor 22, and the eighth roller 51 form the sheet driving unit 60. The movement of the elongated sheet 23 shown in FIG. 6 is controlled by the sheet driving unit 60. The sheet driving unit 60 achieves the above-described control of the movement of the sheet by storing the above-described T1, T2, Δt, θ2 (moving speed of the elongated sheet 23) and the rules for moving the sheet, counting, using a timer, an elapsed time from the start of rotation of the first motor 20 and an elapsed time from the stop of rotation of the first motor 20, as well as an elapsed time from the start of rotation of the third motor 22 and an elapsed time from the stop of rotation of the third motor 22, and controlling the rotation of the third motor (start of rotation, stop of rotation, rotation speed) based on them. It should be noted that the controller 10 is implemented as an LSI, which is a typical integrated circuit. The manner of integrating circuits is not limited to LSI, and the controller 10 may be implemented using a dedicated circuitry or a general purpose processor. Further, a FPGA (Field Programmable Gate Array) that is programmable after an LSI is fabricated, or a reconfigurable processor that allows connection and reconfiguration of circuit cells in an LSI may be used.

The operating section 4 includes a switch for turning on and off the power supply to the main body 2. The operating section 4 also includes a function to start and stop the operation of the main body 2. When the operation of the main body 2 is started, the main body 2 is controlled by the controller 10 to start wiping the floor with making forward and backward movements in the room. When the operation of the main body 2 is stopped, the main body 2 stops the movement. While the power supply to the main body 2 in turned on, the display section 5 is controlled by the controller 10 to display information such as the volume of the liquid contained in the container 15 and the remaining power of the battery 9. The battery 9 is controlled by the controller 10 to supply power to the operating section 4, the display section 5, the liquid ejector 17, the water level sensing unit 70, the first motor 20, the second motor 21, the third motor 22, the sheet sensing unit 73, the information processing unit 74, and the camera 75. The water level sensing unit 70 is disposed in the container 15 and senses the volume of the liquid in the container 15. If the volume of the liquid becomes equal to or lower than a predetermined volume, the display section 5 displays an indication to notify the user that the remaining volume of the liquid is equal to or lower than the predetermined amount.

It should be noted that the user can select, by operating the operating section 4, whether to perform the dry type cleaning without using the liquid or the wet type cleaning using a small amount of the liquid, and the liquid ejector 17 ejects the liquid as described above only when the wet type cleaning is selected. If the water level sensing unit 70 has sensed that the liquid level is equal to or smaller than the predetermined level, the user cannot select the wet type cleaning.

The sheet sensing unit 73 is disposed to the first sheet containing unit 27, and detects whether or not the elongated sheet 23 is wound on the surface of the first cylindrical member 24, or whether or not the thickness of the wound elongated sheet 23 exceeds a predetermined thickness. Whether or not the elongated sheet 23 is wound on the first cylindrical member 24 can be determined, for example, by detecting whether or not the surface of the first cylindrical member 24 is exposed. If the sheet sensing unit 73 determines that there is no elongated sheet 23 on the surface of the first cylindrical member 24 or the thickness of the wound elongated sheet 23 does not exceed the predetermined thickness, control is exerted so as not to activate the third motor 22, and the display section 5 displays an indication to notify the user that there is no elongated sheet 23 on the first cylindrical member 24.

The information processing unit 74 processes positional information of the main body 2 obtained from image information taken by the camera unit 75, and processes information for instructing the first motor 20, the second motor 21, and the third motor 22 such that no uncleaned area is left in the room. This allows cleaning the entire area in the room. The camera unit 75 is disposed in the main body 2. When the main body 2 moves in the room into every corner by combining forward and backward movements, the camera unit 75 controlled by the controller 10 images the surroundings to allow detecting from the image information that in which direction and by how much distance the main body 2 has moved from the position where the operation of the main body 2 is started.

FIG. 11 shows a state where a cover 77 is attached to the elongated sheet wound on the first cylindrical member 24. When the cover 77 having a C-shape is attached to cover the elongated sheet 23 wound on the first cylindrical member 24, except a portion of the elongated sheet 23 extending toward the second cylindrical member 25, the elongated sheet 23 is prevented from unwinding from the first cylindrical member 24. This improves handling of the first cylindrical member having the elongated sheet 23 before it is placed in the first sheet containing unit 27. Of course, the cover 77 is removed when the first cylindrical member 24 having the elongated sheet 23 is placed in the first sheet containing unit 27. The “C-shape” as used herein refers to a shape that has an opening 77a, wherein a segment connecting a first end 77b of the opening 77a contacting the elongated sheet 23 and the center of the first cylindrical member 24 and a segment connecting a second end 77c of the opening 77a of the cover 77 contacting the elongated sheet 23 and the center of the first cylindrical member 24 form an angle α of less than 180 degrees, and a distance D1 between the first end 77b and the second end 77c is smaller than a diameter D2 formed by the elongated sheet 23 wound on the first cylindrical member 24. If the angle α is equal to or greater than 180 degrees, the cover 77 attached to cover the elongated sheet 23 easily come off rightward relative to FIG. 11. By proving the angle α of less than 180 degrees, the cover 77 does not come off rightward relative to FIG. 11 unless the opening 77a is further opened such that the distance D1 between the first end 77b and the second end 77c becomes equal to or greater than the diameter D2.

Next, operation for cleaning the floor surface 55 in a room is described.

As the user operates the operating section 4 to turn on the power supply to the main body 2, the main body 2 becomes ready to move. Further, as the user operates the operating section 4 to select the wet type cleaning mode or the dry type cleaning mode, whether or not to eject the liquid from the liquid ejector 17 while the main body 2 is moving is determined. Further, when the user operates the operating section 4 to start the operation, the main body 2 can start moving if it is detected that the elongated sheet 23 is attached to the main body 2 and is wound on the surface of the first cylindrical member 24. By controlling the first motor 20 and the second motor 21 based on processing of the image information taken by the camera unit 75, the main body 2 moves in the room in a self-propelled manner. While the main body 2 is moving, the elongated sheet 23 pressed onto the floor surface by the third cylindrical member 40 cleans the floor surface. For cleaning, the elongated sheet 23 moves in the front-back direction of the main body 2, as shown in FIG. 1. That is, the width direction of the elongated sheet 23 is the left-right direction of the main body 2, and the first wheel 6 and the second wheel 7 are positioned within the width area of the elongated sheet when the main body 2 is viewed from front. Thus, while the main body 2 makes a forward movement for cleaning, the first wheel 6 and the second wheel 7 run on a portion of the floor surface that has been cleaned with the elongated sheet 23, and this prevents dust on the floor surface from adhering to the first wheel 6 and the second wheel 7. During the cleaning operation, the liquid is not eject from the liquid ejector 17 if the dry type cleaning mode is selected before the operation is started, and the liquid is ejected from the liquid ejector 17 if the wet type cleaning mode is selected before the operation is started.

Next, operation of the elongated sheet 23 is described. As the third motor 22 is activated and the second cylindrical member 25 on which the elongated sheet 23 is wound rotates in the direction of arrow the elongated sheet 23 wound on the first cylindrical member 24 is pulled out from the first cylindrical member 24 and is pressed onto the floor surface by the third cylindrical member 40 to clean floor surface. In the case of the wet type cleaning, a portion of the elongated sheet 23 that has not yet been brought into contact with the floor surface and is wetted with the liquid ejected from the liquid ejector 17 is brought into contact with the floor surface to clean the floor surface. The difference between the dry type cleaning and the wet type cleaning lies only in the presence or absence of the liquid ejection from the liquid ejector 17. By repeating this operation, portions of the elongated sheet 23 that have not yet been brought into contact with the floor surface are sequentially fed and brought into contact with the floor surface to effect cleaning, thereby achieving cleaning of the floor surface in a clean manner. This allows avoiding such a situation that the cleaning operation is continued with the same portion of the elongated sheet 23 that has caught a full of dust and cannot catch any more dust being in contact with the floor surface.

Next, how the elongated sheet 23 is replaced is described. First, a state where the elongated sheet 23 is attached to the main body 2, as shown in FIG. 2, is described. As the first cylindrical member 24 placed in the first sheet containing unit 27 is pulled in the direction of arrow C, the first cylindrical member 24 begins to move in the direction of arrow C with the first spring 36 being compressed, and the largest diameter portion of the turns of the elongated sheet 23 wound on the first cylindrical member 24 passes through the imaginary line connecting the center of the second roller 34 and the center of the third roller 35, completing removal of the first cylindrical member 24 from the first sheet containing unit 27. Further, as the second cylindrical member 25 placed in the second sheet containing unit 31 is pulled in the direction opposite from the direction of arrow H, the second cylindrical member 25 begins to move in the opposite from the direction of arrow H with the second spring 53 being compressed, and the largest diameter portion of the turns of the elongated sheet 23 wound on the second cylindrical member 25 passes through the imaginary line connecting the center of the seventh roller 50 and the center of the ninth roller 52, completing removal from the second sheet containing unit 31. It should be noted that the elongated sheet 23 can be attached to the main body 2 by reversing the order of the above-described removing operation.

To simplify the operation to replace the elongated sheet 23, it is desired to integrate the plurality of parts. By forming an integrated component (which will hereinafter be referred to as “cleaning cartridge”) 80, which integrates the first cylindrical member 24, the first sheet containing unit 27, the sheet contacting unit 29, the second sheet containing unit 31, the second cylindrical member 25, and the elongated sheet 23, such as it is removable from the main body 2, the time taken for the replacing operation by the user can be shortened. Power transmission from the third motor 22 to the eighth roller 51 may, for example, be achieved by providing a worm on the third motor 22 and a worm wheel that is coaxial with the axis of rotation of the eighth roller 51. When the cleaning cartridge is removed, the worm is disengaged from the worm wheel. When the cleaning cartridge is attached to the main body 2, the worm is engaged with the worm wheel. It should be noted that the cleaning cartridge needs to include at least the first cylindrical member 24 for holding the one end 23a of the elongated sheet 23 and the second cylindrical member 25 for holding the other end of the elongated sheet 23, and component parts may be added or the configuration may be changed as appropriate. In this case, by covering the elongated sheet 23 wound on the first cylindrical member 24 with the above-described cover 77, except a portion of the elongated sheet 23 to be pulled out toward the second cylindrical member 25, the elongated sheet 23 is prevented from unwinding from the first cylindrical member 24, and this improves handling of the first cylindrical member 24 having the elongated sheet 23 thereon, or the cleaning cartridge 80.

The main body 2 is not necessarily be a unitary part integrating the individual components, and a portion of the main body 2 may be formed as a unit which is removable from the other portions of the main body 2. For example, the first sheet containing unit 27, the sheet contacting member 40 (or the sheet contacting unit 29), and the second sheet containing unit 31 may be formed as a single unit, or a part of them may be formed as a single unit, or all or part of them and other portions may be formed as a single unit. The above-described cleaning cartridge is one example of this unit.

In the above-description, in order to move the elongated sheet 23 by rotating the second cylindrical member 25, the eighth roller 51 to which the driving force generated by the third motor 22 is transmitted contacts the surface of the elongated sheet 23 wound on the second cylindrical member 25 to move the elongated sheet 23. As an alternative to the use of the eighth roller 51 to impart the moving force to the elongated sheet 23, the eighth roller may be disposed apart from the surface of the elongated sheet 23, and an additional roller may be provided such that a belt member is wrapped around the additional roller and the eighth roller and the belt member may be circulated with being in contact with the surface of the elongated sheet 23 wound on the second cylindrical member 25. This ensures a large contact area between the elongated sheet 23 and the belt member, and thus facilitates avoiding slip (a state where the elongated sheet 23 wound on the second cylindrical member 25 is not moved even when the eighth roller 51 rotates), thereby allowing more reliably imparting a moving force to the elongated sheet 23 (or a rotational force to the second cylindrical member 25). It should be noted that the movement of the elongated sheet 23 may be achieved by directly driving the second cylindrical member 25 to rotate.

It should be noted that the wet type cleaning described in this embodiment is not an operation to wipe the surface to be cleaned with the elongated sheet 23 that is once wetted with water and then squeezed, but is an operation to catch dust on the surface to be cleaned by bringing the elongated sheet 23 which is wetted with a liquid to a degree that does not require squeezing into contact with the surface to be cleaned and moving the elongated sheet 23.

Further, a roller member that partially contacts the elongated sheet 23 may be provided between the first cylindrical member 24 and the third cylindrical member 40 in order to change the path of the elongated sheet 23. Further, a roller member that partially contacts the elongated sheet 23 may be provided, as appropriate, between the second cylindrical member 25 and the third cylindrical member 40 in order to change the path of the elongated sheet 23.

Although the above-described sheet contacting member 40 is in the form of a cylindrical member, the sheet contacting member 40 is not limited to a cylindrical member.

Hereinafter, the above-described embodiments are summarized. In the following description, advantageous effects are described with assuming that the surface treating apparatus of the disclosure is configured as a floor wiping machine for cleaning the floor surface.

A first aspect of the disclosure is a surface treating apparatus comprising a main body configured to move on a surface to be treated and treat the surface to be treated, the main body comprising: a first sheet containing unit configured to contain an elongated sheet; a second sheet containing unit configured to contain the elongated sheet coming from the first sheet containing unit; a sheet driving unit configured to pull out the elongated sheet from the first sheet containing unit and move the elongated sheet toward the second sheet containing unit when the main body is making a forward movement; a sheet contacting member configured to contact one side of the elongated sheet moving from the first sheet containing unit toward the second sheet containing unit and rotate along with the movement of the elongated sheet to bring the other side of the elongated sheet into contact with the surface to be treated when the main body is making the forward movement; a wheel unit; and a housing configured to hold the first sheet containing unit, the second sheet containing unit, the sheet contacting member, the sheet driving unit, and the wheel unit. For example, the first sheet containing unit contains a first holding member configured to hold one end of the elongated sheet. The second sheet containing unit contains a second holding member configured to hold the other end of the elongated sheet.

According to this configuration, when the main body moves on the floor surface, the elongated sheet, which catches dust on the floor surface, moves with contacting the sheet contacting member, which rotates along with the movement of the elongated sheet. This prevents dragging between the elongated sheet and the sheet contacting member when the elongated sheet is moving, and allows smoothly changing a used portion (that has contacted the floor surface) of the elongated sheet contacting the sheet contacting member with an unused portion (that has not yet contacted the floor surface) of the elongated sheet. In this manner, the floor surface can be wiped using sequentially fed unused portions of the elongated sheet.

A second aspect of the disclosure is the surface treating apparatus of the first aspect, wherein the sheet contacting member is partially or entirely disposed anteriorly to the first sheet containing unit and the second sheet containing unit.

According to this configuration, the elongated sheet contacting the sheet contacting member can reach a position anterior to the first sheet containing unit and the second sheet containing unit before the sheet containing units reach the position, and this allows the elongated sheet contacting the sheet contacting member to reach, even if there is an obstacle in front of the main body during cleaning while the main body is making a forward movement, the base (vicinity) of the obstacle before the first sheet containing unit and/or the second sheet containing unit hits the obstacle. This allows increasing a cleanable area, such as allowing cleaning of the base of an obstacle, and decreasing a so-called unwiped area.

A third aspect of the disclosure is the surface treating apparatus of the first or second aspect, wherein, when the main body is making a forward movement, the sheet contacting member is partially or entirely positioned anteriorly to the foremost end position of the housing. It should be noted that the sheet contacting member may be partially or entirely disposed anteriorly to the foremost end position of the housing, or may be moved forward such that the sheet contacting member is partially or entirely positioned anteriorly to the foremost end position of the housing when the main body makes a forward movement.

According to this configuration, the elongated sheet contacting the sheet contacting member can reach a position in front thereof earlier than the housing of the main body, and this allows the elongated sheet contacting the sheet contacting member to reach, even if there is an obstacle in front of the main body during cleaning while the main body is making a forward movement, the base (vicinity) of the obstacle before the housing hits the obstacle. This allows increasing a cleanable area, such as allowing cleaning of the base of an obstacle, and decreasing a so-called unwiped area.

A fourth aspect of the disclosure is the surface treating apparatus of the first or second aspect, wherein, when the main body is making a forward movement, the sheet contacting member is positioned such that the sheet contacting member is partially or entirely exposed at a position anteriorly to the foremost end position of the housing when the main body is viewed from above. It should be noted that the sheet contacting member may be disposed such that the sheet contacting member is partially or entirely exposed at a position anteriorly to the foremost end position of the housing, or may be moved forward such that the sheet contacting member is partially or entirely exposed at a position anteriorly to the foremost end position of the housing when the main body makes a forward movement.

Advantageous effects provided by this configuration are the same as those described for the third aspect of the disclosure.

A fifth aspect of the disclosure is the surface treating apparatus of any one of the first to fourth aspects, wherein the elongated sheet is moved in the front-back direction of the main body, the sheet contacting member is disposed anteriorly to the wheel unit, and the wheel unit is disposed within a width area of the elongated sheet when the main body is viewed from front.

It should be noted that the description “the elongated sheet is moved in the front-back direction of the main body” means that the direction of movement of the elongated sheet when it moves from the first sheet containing unit via the sheet contacting member to the second sheet containing unit is the front-back direction of the main body, that is, the elongated sheet moves in a state where the width direction of the sheet (the direction perpendicular to the longitudinal direction of the elongated sheet) coincides with the left-right direction of the main body.

According to this configuration, when the main body is making a forward movement, the wheel unit passes through an area on the floor surface after the elongated sheet contacting the sheet contacting member has passed through the area, and this allows preventing the wheel unit from being contaminated. Preventing the wheel unit from being contaminated allows avoiding such a situation that dust adhering to the wheel unit falls off from the wheel unit onto the cleaned floor surface.

A sixth aspect of the disclosure is the surface treating apparatus of any one of the first to fifth aspects, wherein the sheet contacting member comprises an elastic member on the outer circumference thereof, and the elastic member is compressively deformed on the surface to be treated due to the weight of the main body.

According to this configuration, the elongated sheet is pressed via the sheet contacting member onto the floor surface due to the weight of the main body, and this allows catching even contamination which is relatively not easy to be removed from the floor surface by strongly scrubbing the floor surface with the elongated sheet. Further, compressively deforming the elastic member on the floor surface allows increasing a contact area of the elongated sheet with the floor surface, and this allows achieving more reliable cleaning.

A seventh aspect of the disclosure is the surface treating apparatus of any one of the first to sixth aspects, wherein the elongated sheet passed through the sheet contacting member moves toward the second sheet containing unit with the other side of the elongated sheet facing upward, and the elongated sheet is wound on the second sheet containing unit with the other side of the elongated sheet facing inward. The description “with the other side of the elongated sheet facing upward” means a state where the other side of the elongated sheet does not face the floor surface when the main body is placed on the floor surface, and encompasses cases where the elongated sheet moves with the other side thereof facing directly above, as well as the elongated sheet moves with the other side thereof facing obliquely upward. Further, the description “wound . . . with the other side of the elongated sheet facing inward” means that the elongated sheet is wound with the one side of the elongated sheet facing outward and being exposed, and with the other side of the elongated sheet facing and stacked on the one side of the already wound elongated sheet.

According to this configuration, dust caught by the elongated sheet from the floor surface is prevented from falling on the floor surface. Further, in a state where a portion of the elongated sheet catching dust (a used portion of the elongated sheet) is contained in the second sheet containing unit, the used surface portion (which has contacted the floor surface) is not exposed outward, and this allows avoiding such a situation that dust once caught on the elongated sheet falls on the cleaned floor surface.

An eighth aspect of the disclosure is the surface treating apparatus of any one of the first to seventh aspects, wherein, when the main body makes a forward movement by a predetermined distance, the sheet driving unit moves the elongated sheet such that a moving distance of the elongated sheet while the main body moves by the predetermined distance is smaller than the predetermined distance. The description “moving distance of the elongated sheet” means a distance through which the elongated sheet moves from first sheet containing unit to the second sheet containing unit, i.e., a length through which the elongated sheet moves to pass through the sheet contacting member.

According to this configuration, unused portions of the elongated sheet are fed to the sheet contacting member such that an amount of decrease of unused portions of the elongated sheet is reduced, and this allows cleaning a wider area with the elongated sheet having a finite length.

A ninth aspect of the disclosure is the surface treating apparatus of any one of the first to eighth aspects, wherein, when the main body makes a forward movement, the sheet driving unit moves the elongated sheet at a moving speed smaller than a moving speed of the main body.

According to this configuration, unused portions of the elongated sheet are fed to the sheet contacting member such that an amount of decrease of unused portions of the elongated sheet is reduced, and this allows cleaning a wider area with the elongated sheet having a finite length.

A tenth aspect of the disclosure is the surface treating apparatus of any one of the first to ninth aspects, wherein, when the main body starts a forward movement in a state where the elongated sheet is not moved, the sheet driving unit does not move the elongated sheet for a predetermined period. It should be noted that the “predetermined period” may be determined in any manner, and may, for example, be a period until a predetermined time elapses, or a period taken by the main body to make a forward movement by a predetermined distance.

According to this configuration, when the main body makes a forward movement, a movement of the elongated sheet can be started after a predetermined amount of dust is collected on the elongated sheet, and this allows cleaning a wider area with the elongated sheet having a finite length.

An eleventh aspect of the disclosure is the surface treating apparatus of any one of the first to tenth aspects, wherein the sheet driving unit starts moving the elongated sheet after a predetermined period has elapsed from the start of a forward movement of the main body, and stops moving the elongated sheet after a predetermined period has elapsed from the start of the movement of the elongated sheet even when the main body is making a forward movement. It should be noted that the “predetermined period” may be determined in any manner, and may, for example, be a period until a predetermined time elapses, or a period taken by the main body to make a forward movement by a predetermined distance. Further, the “predetermined period” with respect to the description “after a predetermined period has elapsed from the start of a forward movement of the main body” and with respect to the description “after a predetermined period has elapsed from the start of the movement of the elongated sheet” may be the same length of period or different lengths of periods. Still further, in a case where the movement of the elongated sheet is controlled with setting the “predetermined period” as a period taken by the main body to make a forward movement by a predetermined distance, the control can be achieved, for example, based on a distance of the forward movement detected by detecting the number of rotations of the wheel unit when the main body is making the forward movement.

According to this configuration, the movement of the elongated sheet can be stopped as appropriate even when the main body is moving, and this allows cleaning a wider area with the elongated sheet having a finite length.

A twelfth aspect of the disclosure is the surface treating apparatus of any one of the first to eleventh aspects, wherein, when the main body stops a forward movement while the elongated sheet is moving, the sheet driving unit continues moving the elongated sheet for a predetermined period from the stop of the forward movement of the main body, and then stops moving the elongated sheet. It should be noted that the “predetermined period” may be determined in any manner, and may, for example, be a period until a predetermined time elapses.

According to this configuration, when the main body stops a forward movement, a used portion of the elongated sheet contacting the sheet contacting unit can be replaced with an unused portion of the elongated sheet portion, thereby allowing restarting the cleaning operation using the unused portion of the elongated sheet when the main body starts a forward movement again or starts a backward movement.

A thirteenth aspect of the disclosure is the surface treating apparatus of any one of the first to twelfth aspects, wherein, when the main body stops a forward movement while the elongated sheet is not moved, the sheet driving unit does not move the elongated sheet at least while the main body stops.

The state where the elongated sheet is not moved while the main body is making a forward movement is a state where the elongated sheet has not yet caught a predetermined amount of dust and the same portion of the elongated sheet contacting the floor surface can be used to catch dust when the main body starts a forward movement again. According to the above-described configuration, the elongated sheet is not moved at least while the main body stops, and this allows avoiding wastefully moving the elongated sheet to feed unused portions of the elongated sheet to the sheet contacting member, thereby allowing reducing an amount of decrease of unused portions of the elongated sheet.

A fourteenth aspect of the disclosure is the surface treating apparatus of any one of the first to thirteenth aspects, wherein the main body comprises a sheet movement resisting unit configured to resist a movement of the elongated sheet from the first sheet containing unit to the second sheet containing unit due to friction between the elongated sheet and the surface to be treated when the main body is making a backward movement. In the previously described embodiments, the first spring 36 and the third roller 35 forms the sheet movement resisting unit, where the first spring 36 presses the third roller toward the elongated sheet 23 wound on the first cylindrical member 24 so that the first cylindrical member 24 is not easily rotated.

According to this configuration, when the main body is making a backward movement, the elongated sheet contacting the surface to be treated by being pressed by the sheet contacting member is prevented from being moved from the first sheet containing unit to the second sheet containing unit due to friction between the elongated sheet and the surface to be treated, resulting in reducing the amount of reduction of unused portions of the elongated sheet, which would otherwise be wastefully fed to the sheet containing unit.

A fifteenth aspect of the disclosure is the surface treating apparatus of any one of the first to fourteenth aspects, wherein the main body comprises: a container configured to contain a liquid; and a liquid applying unit configured to apply the liquid contained in the container to the elongated sheet before the elongated sheet reaches the sheet contacting unit.

According to this configuration, wet type cleaning, where the elongated sheet wetted with the liquid is used to wipe the floor surface, can be achieved, thereby allowing cleaning the floor surface with improved cleanness. Further, if the liquid is an alcohol-containing liquid, finishing the floor surface with improved cleanness as well as sterilization can be achieved.

A sixteenth aspect of the disclosure is a cleaning cartridge forming a part of the surface treating apparatus of any one of the first to fifteenth aspects, wherein the cleaning cartridge is removable from the housing, and the cleaning cartridge comprises the elongated sheet, the first holding member configured to hold one end of the elongated sheet, and the second holding member configured to hold the other end of the elongated sheet. The description “removable from the housing” means that the cleaning cartridge is removable from portions of the main body other than the cleaning cartridge.

According to this configuration, when a used elongated sheet is replaced with a new elongated sheet, the time taken for the replacing operation by the user can be shortened.

What is claimed is:

1. A surface treating apparatus comprising a main body configured to move on a surface to be treated and treat the surface to be treated, the main body comprising:
a first sheet containing unit configured to contain an elongated sheet;
a second sheet containing unit configured to contain the elongated sheet coming from the first sheet containing unit;
a sheet driving unit configured to pull out the elongated sheet from the first sheet containing unit and move the elongated sheet toward the second sheet containing unit when the main body is making a forward movement;
a sheet contacting member configured to contact one side of the elongated sheet moving from the first sheet containing unit toward the second sheet containing unit and rotate along with the movement of the elongated sheet to bring the other side of the elongated sheet into contact with the surface to be treated when the main body is making the forward movement;
a wheel unit; and
a housing configured to hold the first sheet containing unit, the second sheet containing unit, the sheet driving unit, the sheet contacting member, and the wheel unit.

2. The surface treating apparatus as claimed in claim 1, wherein the sheet contacting member is partially or entirely disposed anteriorly to the first sheet containing unit and the second sheet containing unit.

3. The surface treating apparatus as claimed in claim 1, wherein, when the main body is making a forward movement, the sheet contacting member is partially or entirely positioned anteriorly to the foremost end position of the housing.

4. The surface treating apparatus as claimed in claim 1, wherein, when the main body is making a forward movement, the sheet contacting member is positioned such that the sheet contacting member is partially or entirely exposed at a position anteriorly to the foremost end position of the housing when the main body is viewed from above.

5. The surface treating apparatus as claimed in claim 1, wherein the elongated sheet is moved in the front-back direction of the main body, the sheet contacting member is disposed anteriorly to the wheel unit, and the wheel unit is disposed within a width area of the elongated sheet when the main body is viewed from front.

6. The surface treating apparatus as claimed in claim 1, wherein the sheet contacting member comprises an elastic member on the outer circumference thereof, and the elastic member is compressively deformed on the surface to be treated due to the weight of the main body.

7. The surface treating apparatus as claimed in claim 1, wherein the elongated sheet passed through the sheet contacting member moves toward the second sheet containing unit with the other side of the elongated sheet facing upward, and the elongated sheet is wound on the second sheet containing unit with the other side of the elongated sheet facing inward.

8. The surface treating apparatus as claimed in claim 1, wherein, when the main body makes a forward movement by a predetermined distance, the sheet driving unit moves the elongated sheet such that a moving distance of the elongated sheet while the main body moves by the predetermined distance is smaller than the predetermined distance.

9. The surface treating apparatus as claimed in claim 1, wherein, when the main body makes a forward movement, the sheet driving unit moves the elongated sheet at a moving speed smaller than a moving speed of the main body.

10. The surface treating apparatus as claimed in claim 1, wherein, when the main body starts a forward movement in a state where the elongated sheet is not moved, the sheet driving unit does not move the elongated sheet for a predetermined period.

11. The surface treating apparatus as claimed in claim 1, wherein the sheet driving unit starts moving the elongated sheet after a predetermined period has elapsed from the start of a forward movement of the main body, and stops moving the elongated sheet after a predetermined period has elapsed from the start of the movement of the elongated sheet even when the main body is making a forward movement.

12. The surface treating apparatus as claimed in claim 1, wherein, when the main body stops a forward movement while the elongated sheet is moving, the sheet driving unit continues moving the elongated sheet for a predetermined period from the stop of the forward movement of the main body, and then stops moving the elongated sheet.

13. The surface treating apparatus as claimed in claim 1, wherein, when the main body stops a forward movement while the elongated sheet is not moved, the sheet driving unit does not move the elongated sheet at least while the main body stops.

14. The surface treating apparatus as claimed in claim 1, wherein the main body comprises a sheet movement resisting unit configured to resist a movement of the elongated sheet from the first sheet containing unit to the second sheet containing unit due to friction between the elongated sheet and the surface to be treated when the main body is making a backward movement.

15. The surface treating apparatus as claimed in claim 1, wherein the main body comprises:
a container configured to contain a liquid; and
a liquid applying unit configured to apply the liquid contained in the container to the elongated sheet before the elongated sheet reaches the sheet contacting member.
